(19) United States
(12) Patent Application Publication
(10) Pub. No.: US 2013/0217938 A1
(43) Pub. Date: Aug. 22, 2013

(54) PROCESSES FOR CONVERTING HYDROGEN SULFIDE TO CARBON DISULFIDE

(71) Applicant: Marathon GTF Technology, Ltd., (US)

(72) Inventors: John J. Waycuilis, Cypress, TX (US); William J. Turner, Seabrook, TX (US)

(73) Assignee: MARATHON GTF TECHNOLOGY, LTD., Houston, TX (US)

(21) Appl. No.: 13/760,291

(22) Filed: Feb. 6, 2013

Related U.S. Application Data
(60) Provisional application No. 61/599,498, filed on Feb. 16, 2012.

(51) Int. Cl. C01B 31/26

(52) U.S. Cl. CPC C01B 31/265
USPC 585/324; 423/443

(57) ABSTRACT

Processes for forming carbon disulfide from a gas stream containing hydrogen sulfide. A gaseous stream comprising lower molecular weight alkanes and hydrogen sulfide may be contacted with sufficient bromine at a temperature of from about 250° C. to about 530° C. to convert substantially all of said hydrogen sulfide to carbon disulfide. The gaseous stream may contain from about 0.001 to about 20 mol % hydrogen sulfide. The molar ratio of bromine to hydrogen sulfide may be about 2:1.

### BACKGROUND OF THE INVENTION

The present invention relates generally to processes for removing hydrogen sulfide from gas streams by reaction with alkanes and bromine to form carbon disulfide and, in one or more embodiments, to forming carbon disulfide as a product in chemical processes for converting lower molecular weight alkanes to higher hydrocarbons, olefins or mixtures thereof.

Natural gas, a fossil fuel, is primarily composed of methane and other light alkanes and has been discovered in large quantities throughout the world. When compared to other fossil fuels, natural gas is generally a cleaner energy source. For example, crude oil typically contains impurities, such as heavy metals, which are generally not found in natural gas. By way of further example, burning natural gas produces far less carbon dioxide than burning coal, per unit of heat energy released. However, challenges are associated with the use of natural gas in place of other fossil fuels. Many locations in which natural gas has been discovered are far away from populated regions and, thus, do not have significant pipeline structure and/or market demand for natural gas. Due to the low density of natural gas, the transportation thereof in gaseous form to more populated regions is expensive. Accordingly, practical and economic limitations exist to the distance over which natural gas may be transported in its gaseous form.

Cryogenic liquefaction of natural gas to form liquefied natural gas (often referred to as “LNG”) is often used to more economically transport natural gas over large distances. However, this LNG process is generally expensive, and there are limited regasification facilities in only a few countries for handling the LNG. Converting natural gas to higher molecular weight hydrocarbons which, due to their higher density and value, are able to be more economically transported as a liquid can significantly expand the market for natural gas, particularly stranded natural gas produced far from populated regions. While a number of processes for the conversion of natural gas to higher molecular weight hydrocarbons have been developed, these processes have not gained widespread industry acceptance due to their limited commercial viability. Typically, these processes suffer from undesirable energy and/or carbon efficiencies that have limited their use.

Further, hydrogen sulfide (H₂S) is a toxic and corrosive contaminant found in many natural gas reservoirs or other gas sources such as “bio-gas” produced from the anaerobic microbiological decomposition of organic wastes from landfills, sewage treatment plants, etc. As such, hydrogen sulfide should be removed from a gas stream prior to use. Because hydrogen sulfide is toxic, it may corrode copper tubing and other metals found in natural gas combustion appliances, and if left in the gas stream, would burn to noxious sulfur oxides (SOₓ) which are air pollutants. In the instance where the gas is used as feedstock to a chemical or fuels production process, such as “gas-to-methanol”, “gas-to-ammonia” or “gas-to-liquids” (Fischer-Tropsch) processes, the hydrogen sulfide must be removed because it can rapidly deactivate or “poison” the catalysts used in the gas conversion processes.

Hydrogen sulfide may be typically first separated from an H₂S-contaminated gas stream using a re-circulated and regenerated H₂S-selective solvent process employing a chemical solvent, such as an aqueous amine, or a physical solvent such as that used in a process marketed under the trade name Selexol. Hydrogen sulfide may be further converted to elemental sulfur via the Claus process. Molten sulfur is typically shipped in heated rail cars or tanker trucks as a liquid and used to produce sulfuric acid, ammonium sulfate or other industrial chemicals, such as carbon disulfide.

Carbon disulfide (CS₂) is a valuable chemical intermediate used in the production of rayon, cellophane and various other industrial and agricultural chemicals. Most carbon disulfide (CS₂) is currently made by the high-temperature reaction of methane with elemental sulfur, much of which is produced from H₂S derived from the refining of crude oil or processing of natural gas. Thus, the production of CS₂ from methane and sulfur is an indirect multistep process, requiring the separation, handling and processing of the hydrogen sulfide, sulfur and methane components, often in separate locations.

Thus, a need exists for a process for directly converting hydrogen sulfide to carbon disulfide without the need to separate hydrogen sulfide from other components of the gas stream being processed.

### BRIEF SUMMARY OF THE INVENTION

To achieve the foregoing and other objects, and in accordance with the purposes of the present invention, as embodied and broadly described herein, one embodiment of the present invention is a process that comprises contacting a gaseous stream comprising lower molecular weight alkanes and hydrogen sulfide with sufficient bromine at a temperature to convert substantially all of said hydrogen sulfide to carbon disulfide.

Another embodiment of the present invention is a process comprising contacting a gaseous stream comprising lower molecular weight alkanes and hydrogen sulfide with bromine at a temperature so as to form alkyl bromides, carbon disulfide and hydrogen bromide and reacting at least a portion of the alkyl bromides in the presence of a suitable catalyst, the hydrogen bromide and the carbon disulfide to form higher molecular weight hydrocarbons, olefins or mixtures thereof.

### BRIEF DESCRIPTION OF THE SEVERAL VIEWS OF THE DRAWINGS

FIG. 1 is a block flow diagram of one embodiment of the processes and systems of the present invention;

FIG. 2 is a block flow diagram of another embodiment of the processes and systems of the present invention;

FIG. 3 is a block flow diagram of yet another embodiment of the processes and systems of the present invention; and

FIG. 4 is a block flow diagram of still another embodiment of the processes and systems of the present invention.

### DETAILED DESCRIPTION OF THE INVENTION

Gas streams that may be used as a feed stock for the methods described herein typically contain lower molecular weight alkanes. As utilized throughout this description, the term “lower molecular weight alkanes” refers to methane, ethane, propane, butane, pentane or mixtures of two or more of these individual alkanes. The lower molecular weight alkanes may be from any suitable source, for example, any source of gas that provides lower molecular weight alkanes, whether naturally occurring or synthetically produced. Examples of sources of lower molecular weight alkanes for use in the processes of the present invention include, but are not limited to, natural gas, coal-bed methane, regasified liquefied natural gas, gas derived from gas hydrates and/or chlathrates, gas derived from anaerobic decomposition of organic matter or biomass, gas derived in the processing of tar sands, and synthetically produced natural gas or alkanes. Combinations of these may be suitable as well in some embodiments.

Suitable sources of bromine that may be used in various embodiments of the present invention include, but are not limited to, elemental bromine, bromine salts, aqueous hydrobromic acid, metal bromide salts, and the like. Combinations may be suitable, but as recognized by those skilled in the art, using multiple sources may present additional complications. Certain embodiments of the methods and systems of the invention are described below. Although major aspects of what is believed to be the primary chemical reactions involved in the methods are discussed in detail as it is believed that they occur, it should be understood that side reactions may take place. One should not assume that the failure to discuss any particular side reaction herein means that that reaction does not occur. Conversely, those that are discussed should not be considered exhaustive or limiting. Additionally, although figures are provided that schematically show certain aspects of the methods of the present invention, these figures should not be viewed as limiting on any particular method of the invention.

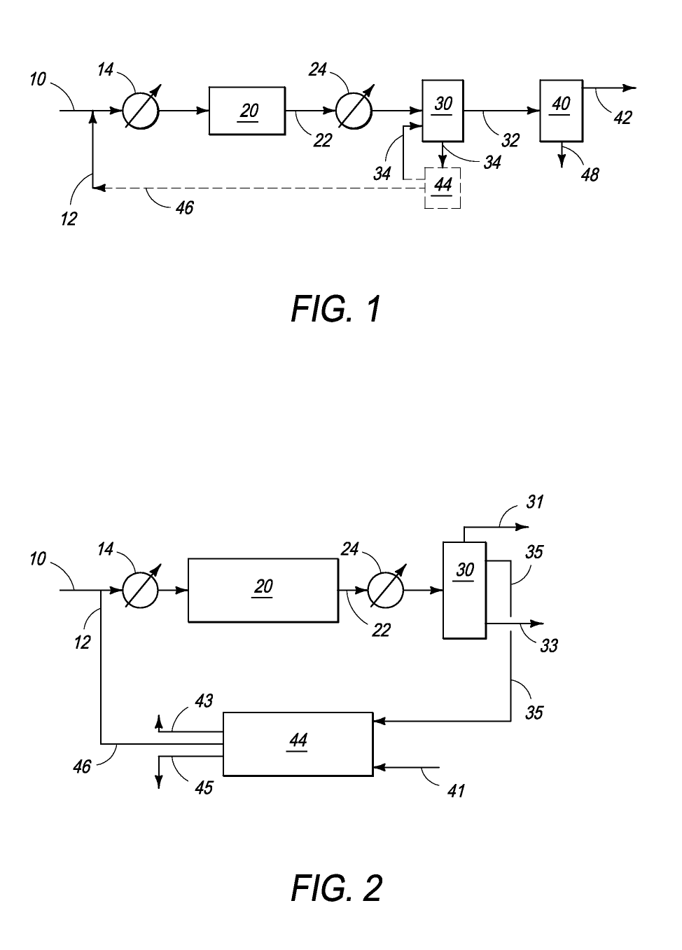

A block flow diagram generally depicting some aspects of certain embodiments of the processes and systems of the present invention is illustrated in FIG. 1 which depicts a stand-alone process for direct removal of low levels of hydrogen sulfide from a gas stream and conversion of hydrogen sulfide to carbon disulfide for sale, storage or further processing. A gas stream that contains methane and which may also contain other lower molecular weight alkanes and from about 0.001 to about 20.0 mol % hydrogen sulfide may be conveyed in a suitable line or conduit 10 and initially combined with bromine via line 12 from a suitable source and heated to a temperature of from about 250° C. to about 530° C. in heat exchanger 14 wherein the bromine, if initially present in liquid form, is vaporized. The mixture may be introduced via line 10 into bromination reactor 20. Applicant has discovered that hydrogen sulfide appears to be more reactive with bromine than lower molecular weight alkanes, for example, methane, as no significant elemental sulfur can be detected in any of the reaction products from reacting a gaseous stream containing lower molecular alkanes and hydrogen sulfide with bromine. If elemental sulfur is formed as an intermediate in the reaction mechanism, the sulfur apparently rapidly reacts with methane or methyl bromide. Irrespective of the actual reaction mechanism, it appears that the overall net reaction may be:

2H₂S+4Br₂+CH₄→CS₂+8HBr

Hydrogen sulfide apparently may be more reactive with bromine (Br₂) than with methane and other lower molecular weight alkanes, as evidenced by the fact that the H₂S may be essentially completely removed to undetectable levels in the presence of an excess of methane.

Considering the general case in which the process is used only for the removal of H2S from an alkane stream composed primarily of methane, the molar ratio of dry bromine vapor to hydrogen sulfide in the mixture introduced into bromination reactor 20 may preferably be near to the stoichiometric ratio of about 2:1. In addition to or in lieu of heat exchanger 14, bromination reactor 20 may have an inlet pre-heater zone (not illustrated) that can heat the mixture to a reaction initiation temperature in the range of about 250° C. to about 530° C.

The effluent gas stream from bromination reactor 20 which contains carbon disulfide and hydrogen bromide may be transported via line 22 and cooled via heat exchanger 24 to a temperature from about 50° C. to about 120° C. before being introduced into a hydrogen bromide removal unit 30 which may consist of one or more vessels in which HBr is removed from the gas stream. As HBr is a polar and easily ionized compound, such removal may involve washing the gas stream. Where the gas stream is contacted with water, hydrogen bromide may be selectively dissolved to form hydrobromic acid. Where the gas stream is contacted with a caustic solution, for example an aqueous solution of sodium hydroxide, hydrogen bromide reacts with sodium hydroxide to form sodium bromide. The resultant HBr or NaBr may be removed from the wash stream 34 by air or chemical oxidation or electrolysis in HBr conversion stage 44 to form elemental bromine which may be recycled via line 46 to the bromine in line 12 that may be combined with the gas stream in line 10.

The resultant gas stream that contains carbon disulfide may be conveyed via line 32 and introduced into separation stage 40 to remove carbon disulfide via line 48. Carbon disulfide is an easily transportable and useful industrial liquid solvent or may be further processed in a variety of chemical processes. As carbon disulfide has a relatively high molecular weight, one manner of removing carbon disulfide from the gas stream is via condensation. For example, the normal boiling point of carbon disulfide is about 46° C. so that cooling the gas stream below this temperature will cause carbon disulfide to condense out of the vapor stream and be removed as a liquid product. Operating at higher pressures may increase the extent of condensation of carbon disulfide from the gas stream, and further, a multi-staged unit operation such as a refluxed absorber may substantially increase the carbon disulfide removal efficiency. The resultant gas stream which is substantially devoid of hydrogen sulfide and carbon disulfide may be transported via line 42 for further processing, storage or sale.

In an alternative embodiment as depicted in FIG. 2, the process is substantially similar to the embodiment shown in FIG. 1, except that the hydrogen bromide separation in unit 30 is performed via distillation. The resultant gas stream which is substantially devoid of hydrogen sulfide and carbon disulfide may be removed from unit 30 via line 31 for further processing, storage or sale, while carbon disulfide may be removed via line 33 for further processing, storage or sale. Hydrogen bromide (HBr) may be converted to elemental bromine by chemical oxidation in stage 44 as depicted in the block flow diagram of FIG. 2 wherein hydrogen bromide may be introduced into HBr conversion stage 44 via line 35 and air or oxygen may also be introduced into HBr conversion stage 44 via line 41. In conversion stage 44, it is believed that the formation of elemental bromine occurs in accordance with the following general overall reaction:

4HBr(g)+O₂(g)→2Br₂(g)+2H₂O(g)

In the embodiment of FIG. 2, the need for a distinct separation stage 40 to remove carbon disulfide from the remaining gas stream may be eliminated.

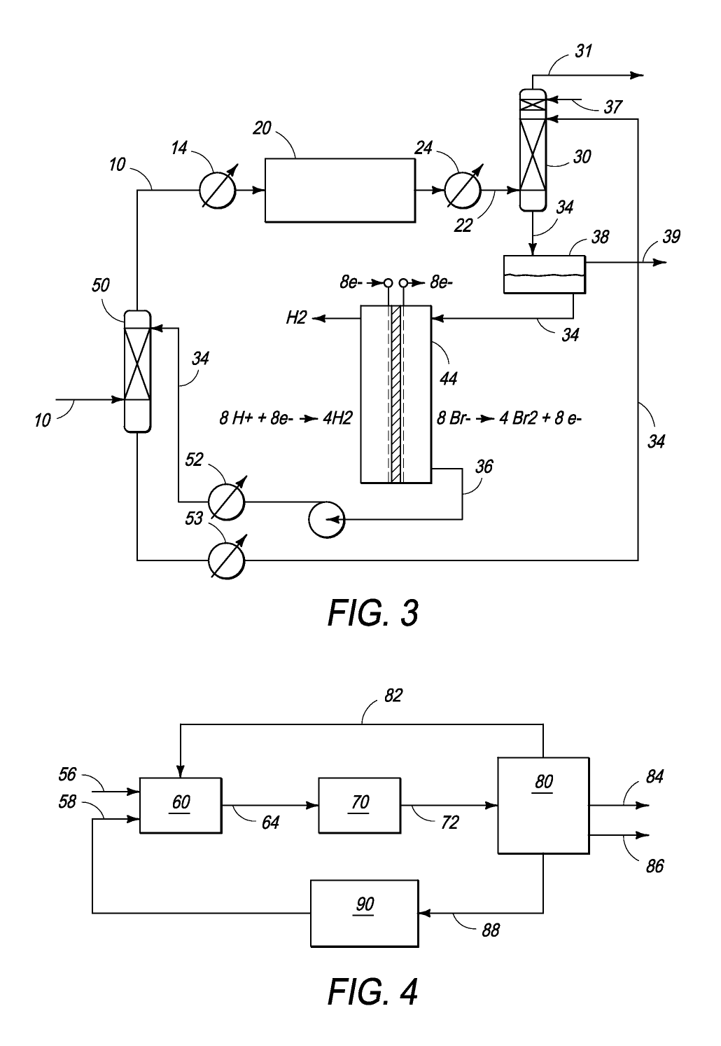

Residual oxidant (oxygen or air) and water may be removed from stage 44 via lines 43 and 45, respectively, while elemental bromine (Br2) may be recycled via lines 46 and 12 and mixed with feed gas stream in line 10 that contains lower molecular weight alkanes and from about 0.001 to about 20.0 mol % hydrogen sulfide.

Where the hydrogen bromide conversion in unit 44 is performed via electrolysis, one or more membrane-type electrolysis cells 44 may be used as depicted in FIG. 3. In this embodiment, a weak hydrogen bromide aqueous solution may be introduced near the top of one or more absorber column 30 serving as the hydrogen bromide removal unit, while the effluent gas stream from bromination reactor 20 which contains carbon disulfide and hydrogen bromide may be introduced into absorber column 30 via line 22 near the lower end thereof. Carbon disulfide condenses as a separate phase and hydrogen bromide may be dissolved into the weak hydrogen bromide aqueous solution thereby forming a strong HBr solution which may be transported via line 34 to settling tank 38 and the resultant gas stream which is substantially devoid of hydrogen sulfide and carbon disulfide may be removed from absorber column 30 via line 42 for further processing, storage or sale. Make up water may be added to absorber column 30 via line 37 as necessary as will be evident to a skilled artisan.

In settling tank 38, carbon disulfide separates from the strong HBr solution and may be removed via line 39 for further processing, storage or sale. The strong HBr solution may be transported to one or more electrolysis cells 44. The membrane or diaphragm in the electrolysis cell permits the flux of H+ ions from anode side to the cathode side but retards the flow of Br− ions and Br₂ from the anode side to the cathode side. Preferably, the membrane may be a cation-exchange membrane or proton-exchange membrane, such as a sulfonated tetrafluoroethylene based fluoropolymer-copolymer, for example sold under the trademark Nafion®, or similar-function cation-exchange membrane. Preferably the solution circulation rate may be controlled such that the strong hydrobromic acid solution is at or near about 48 wt % HBr so that the electrochemical potential required to drive the reaction may be minimized. The bromine-rich solution that results may be removed from the one or more electrolysis cells via line 34 and may preferably be heated to at least about 70° C. but more preferably to about 90° C. via heat exchanger 52, before it may be conveyed via line 34 to the bromine (Br₂) stripper column 50. In the bromine stripper column, inlet gas stream 10 containing lower molecular weight alkanes (such as methane) and from about 0.001 to about 20.0 mol % hydrogen sulfide vaporizes and strips Br₂ out of the heated solution. The stripped solution leaving the Br₂ stripper via line 36 may then be cooled to at least 50° C. via heat exchanger 53, but more preferably to about 30° C., so that trace bromine in the solution is not lost to the purified lower molecular weight (e.g., methane) gas in HBr absorber 30.

A block flow diagram generally depicting some aspects of other embodiments of the processes and systems of the present invention is illustrated in FIG. 4 in which the process of the present invention for conversion of hydrogen sulfide to carbon disulfide may be incorporated into a gas-to-fuels or chemicals process. A gas stream comprising primarily methane and which may also contain other lower molecular weight alkanes and containing hydrogen sulfide in the range of about 0.001 to 20.0 mol % at a pressure in the range of about 1 bar to about 75 bar, may be transported or conveyed via line, pipe or conduit 56 and fed to bromination reactor 60. Dry bromine vapor may be transported or conveyed transported via line, pipe or conduit 58 and also fed to the bromination reactor 60. The gas stream and dry bromine vapor may be separately introduced into bromination reactor 60 as illustrated in FIG. 2 or mixed prior to entry as will be evident to a skilled artisan. In order to convert the hydrogen sulfide present a first amount of bromine, preferably equal to two times the molar ratio of H2S present is added. A second amount of bromine is also added such that the molar ratio of lower methane to dry bromine vapor in the mixture introduced into reactor 60 is in excess of about 2.5:1, and more preferably equal to about 3:1, in order to achieve the preferred excess methane to bromine ratio in the presence of the more reactive hydrogen sulfide present in the inlet gas stream. Reactor 60 may have an inlet pre-heater zone (not illustrated) that can heat the mixture to a reaction initiation temperature in the range of about 250° C. to about 530° C.

In the bromination reactor 60, the lower molecular weight alkanes may be reacted exothermically with dry bromine vapor at a temperature in the range of about 250° C. to about 600° C., and at a pressure in the range of about 1 bar to about 80 bar, and more preferably about 1 bar to 30 bar, to produce gaseous alkyl bromides and hydrobromic acid vapors. As will be evident to a skilled artisan with the benefit of this disclosure, the bromination reaction in bromination reactor 60 may be an exothermic, homogeneous gas-phase reaction or a heterogeneous catalytic reaction. Non-limiting examples of suitable catalysts that may be used in bromination reactor 60 include platinum, palladium, or supported non-stiochiometric metal oxy-halides, such as FeOₓBr_{y} or FeOₓCl_{y} or supported metal oxy-halides, such as TaOF₃, NbOF₃, ZrOF₂, SbOF₃ as described in Olah, et al., J. Am. Chem. Soc. 1985, 107, 7097-7105. It is believed that the upper limit of the operating temperature range may be greater than the upper limit of the reaction initiation temperature range to which the feed mixture is heated due to the exothermic nature of the bromination reaction. In the case of methane, it is believed that the formation of methyl bromide occurs in accordance with the following general overall reaction:

CH₄(g)+Br₂(g)→CH₃Br(g)+HBr(g)

Due to the free-radical mechanism of the homogeneous gas-phase bromination reaction, di-bromomethane and some tri-bromomethane and other alkyl bromides may also be formed. However, this reaction in accordance with the processes of the present invention often occurs with a relatively high degree of selectivity to methyl bromide due to the alkane-to-bromine ratio and the temperature and residence time employed in bromination reactor 60. For example, in the case of the bromination of methane, a methane-to-bromine ratio of about 3:1 at a temperature of about 500° C. and residence time of about 60 seconds is believed to increase the selectivity to mono-halogenated methyl bromide to average approximately 90%. At these conditions, some dibromomethane and only extremely small amounts of tribromomethane approaching the detectable limits also may be formed in the bromination reaction. If a lower methane-to-bromine ratio of approximately 2.6 to 1, a lower temperature of about 400° C. and a shorter residence time of only about 5 to 10 seconds is utilized, selectivity to the mono-halogenated methyl bromide may fall to the range of approximately 65 to 75%. At a methane-to-bromine ratio significantly less than about 2.5 to 1, unacceptable low selectivities to methyl bromide occurs, and, moreover, significant formation of undesirable di-bromomethane, tri-bromomethane, and carbon soot is observed. Higher alkanes, such as ethane, propane and butane, also may be brominated, resulting in mono and multiple brominated species such as ethyl bromides, propyl bromides and butyl bromides. However, as these higher alkanes are substantially more reactive than methane, these will become poly-brominated and may form soot, before significant reaction of methane occurs. Therefore, bromination of the higher alkanes should be carried out separately from the bromination of methane.

As previously noted above with respect to FIG. 1, hydrogen sulfide is apparently more reactive with bromine than with methane so any hydrogen sulfide present in the gas stream will be preferentially converted to carbon disulfide. Regardless of the actual reaction mechanism, it appears that the overall net reaction is:

2H₂S+4Br₂+CH₄→CS₂+8HBr

H₂S is apparently more reactive with Br₂ than with methane, as evidenced by the fact that the H₂S is essentially completely removed to undetectable levels in the presence of an excess of methane.

An effluent that comprises alkyl bromides, carbon disulfide, hydrogen bromide and any unreacted lower molecular weight alkanes may be withdrawn from the bromination reactor 60 via line 64. This effluent may be partially cooled by any suitable means, such as a heat exchanger (not illustrated), as will be evident to a skilled artisan, before flowing to a synthesis reactor 70. The temperature to which the effluent is partially cooled is in the range of about 150° C. to about 420° C. when it is desired to convert the alkyl bromides to higher molecular weight hydrocarbons in synthesis reactor 70, or to range of about 150° C. to about 450° C. when it is desired to convert the alkyl bromides to olefins in synthesis reactor 70. Synthesis reactor 70 is thought to oligomerize the alkyl units so as to form products that comprise olefins, higher molecular weight hydrocarbons or mixtures thereof. In synthesis reactor 70, the alkyl bromides may be reacted exothermically at a temperature range of from about 150° C. to about 450° C., and a pressure in the range of about 1 to 80 bar, over a suitable catalyst to produce desired products (e.g., olefins and higher molecular weight hydrocarbons). The carbon disulfide present during this reaction appears to undergo no significant reaction, or result in deposition or “poisoning” of the catalyst used in the synthesis reactor.

The catalyst used in synthesis reactor 70 may be any of a variety of suitable materials for catalyzing the conversion of the brominated alkanes to product hydrocarbons. In certain embodiments, synthesis reactor 70 may comprise a fixed bed 33 of the catalyst. A fluidized-bed or moving-bed of synthesis catalyst may also be used in certain circumstances, particularly in larger applications and may have certain advantages, such as constant removal of coke and a steady selectivity to product composition. Examples of suitable catalysts include a fairly wide range of materials that have the common functionality of being acidic ion-exchangers and which also contain a synthetic crystalline alumino-silicate oxide framework. In certain embodiments, a portion of the aluminum in the crystalline alumino-silicate oxide framework may be substituted with magnesium, boron, gallium and/or titanium. In certain embodiments, a portion of the silicon in the crystalline alumino-silicate oxide framework may be optionally substituted with phosphorus. The crystalline alumino-silicate catalyst generally may have a significant anionic charge within the crystalline alumino-silicate oxide framework structure which may be balanced, for example, by cations of elements selected from the group H, Li, Na, K or Cs or the group Mg, Ca, Sr or Ba. Although zeolitic catalysts may be commonly obtained in a sodium form, a protonic or hydrogen form (via ion-exchange with ammonium hydroxide, and subsequent calcining) is preferred, or a mixed protonic/sodium form may also be used. The zeolite may also be modified by ion exchange with other alkali metal cations, such as Li, K, or Cs, with alkali-earth metal cations, such as Mg, Ca, Sr, or Ba, or with transition metal cations, such as Ni, Mn, V, W or by treatment with acids. Such chemical treatment and subsequent ion-exchange, may replace the charge-balancing counter-ions, but furthermore may also partially replace ions in the oxide framework resulting in a dealumination or other modification of the crystalline make-up and structure of the oxide framework. The crystalline alumino-silicate or substituted crystalline alumino-silicate may include a microporous or mesoporous crystalline aluminosilicate, but, in certain embodiments, may include a synthetic microporous crystalline zeolite, and, for example, being of the MR structure such as ZSM-5. Moreover, the crystalline alumino-silicate or substituted crystalline alumino-silicate, in certain embodiments, may be subsequently impregnated with an aqueous solution of a Mg, Ca, Sr, or Ba salt, calcined and subsequently washed with and acid solution. In certain embodiments, the synthetic microporous zeolite may be impregnated with an aqueous solution of salts which may be a halide salt, such as a bromide salt, such as MgBr₂ calcined and not subsequently acid-washed, the Mg remaining on the catalyst as an additive. Optionally, the crystalline alumino-silicate or substituted crystalline alumino-silicate may also contain between about 0.1 to about 1 weight % Pt, about 0.1 to 5 weight % Pd, or about 0.1 to about 5 weight % Ni in the metallic state. Although, such materials are primarily initially crystalline, it should be noted that some crystalline catalysts may undergo some dealumination, loss of crystallinity or both either due to initial ion-exchange or impregnation or chemical dealumination treatments or due to operation at the reaction conditions or during regeneration and hence may also contain significant amorphous character, yet still retain significant, and in some cases improved activity and reduced selectivity to coke.

The particular catalyst used in synthesis reactor 70 will depend, for example, upon the particular product hydrocarbons that are desired. For example, when product hydrocarbons having primarily C3, C4 and C5₊ gasoline-range aromatic compounds and heavier hydrocarbon fractions are desired, a ZSM-5 zeolite catalyst may be used. When it is desired to produce product hydrocarbons comprising a mixture of olefins and C₅₊ products, an X-type or Y-type zeolite catalyst or SAPO zeolite catalyst may be used. Examples of suitable zeolites include an X-type, such as 10-X, or Y-type zeolite, although other zeolites with differing pore sizes and acidities may be used in embodiments of the present invention.

In addition to the catalyst, the temperature at which the synthesis reactor 70 is operated is an important parameter in determining the selectivity and conversion of the reaction to the particular product desired. For example, when an X-type or Y-type zeolite catalyst is used and it is desired to produce olefins, it may be advisable to operate synthesis reactor 70 at a temperature within the range of about 250° C. to 500° C. Alternatively, in an embodiment involving a ZSM-5 zeolite catalyst operating in a slightly lower temperature range of about 250° C. to 420° C., cyclization reactions in the synthesis reactor occur such that the C₇₊ fractions contain primarily substituted aromatics and also light alkanes primarily in the C₃ to C₅₊ range. Surprisingly, very little ethane or C₂,-C₃ olefin components are found in the products.

In the example of a gas mixture containing methyl bromide reacting over a ZSM-5 catalyst at a GHSV in the range of about 100 to about 2500 hr−1, at increasing temperatures approaching 400° C., methyl bromide conversion increases towards 90% or greater, however selectivity towards C₅₊ hydrocarbons decreases and selectivity towards lighter products of the process, particularly propane, increases. At temperatures exceeding 550° C., it is believed that a high conversion of methyl bromide to methane and carbonaceous, coke may occur. In the preferred operating temperature range of between about 350° C. and 420° C., as a byproduct of the reaction, a lesser amount of coke may build up on the catalyst over time during operation. Coke build-up may be problematic as it can lead to a decline in catalyst activity over a range of hours, up to hundreds of hours, depending on the reaction conditions and the composition of the feed gas. It is believed that higher reaction temperatures above about 400° C. and more particularly at temperatures above about 420° C., are associated with the formation of methane and favor the thermal cracking of alkyl bromides and formation of carbon or coke, and hence, an increase in the rate of deactivation of the catalyst. Conversely, temperatures at the lower end of the range, particularly below about 350° C. may also contribute to deactivation due to a reduced rate of desorption of heavier products from the catalyst. Hence, operating temperatures within the range of about 350° C. to about 450° C., but preferably in the range of about 375° C. to about 420° C. in the synthesis reactor 70 balance increased selectivity of the desired C₅₊ hydrocarbons and lower rates of deactivation due to lesser carbonaceous coke formation or heavy product accumulation on the catalyst, against higher conversion per pass, which minimizes the quantity of catalyst, recycle rates and equipment size required.

In some embodiments, the catalyst may be periodically regenerated in situ. One suitable method of regenerating the catalyst is to isolate reactor 70 from the normal process flow, purge it with an inert gas at a pressure in a range from about 1 to about 5 bar at an elevated temperature in the range of about 400° C. to about 650° C. This should remove unreacted alkyl bromides and heavier hydrocarbon products adsorbed on the catalyst insofar as is practical. Optionally, the catalyst then may be subsequently oxidized by addition of air or inert gas-diluted air or oxygen to reactor 70 at a pressure in the range of about 1 bar to about 30 bar at an elevated temperature in the range of about 400° C. to about 650° C. Carbon dioxide, carbon monoxide and residual air or inert gas may be vented from reactor 70 during the regeneration period.

In some embodiments a fluidized-bed or moving-bed reactor system may be employed in lieu of a fixed-bed synthesis reactor. In such embodiments, catalyst regeneration may occur in a separate regeneration reactor on a continuous or intermittent basis, as will be evident to a skilled practitioner.

The effluent from synthesis reactor 70, which comprises carbon disulfide, unreacted lower molecular weight alkanes, hydrogen bromide and olefins, higher molecular weight hydrocarbons or mixtures thereof, may be withdrawn from the synthesis reactor 70 via line 72 and transported to a products separation unit 80. Unit 80 can employ any suitable method of hydrogen bromide removal, such as use of a aqueous wash stream, or dehydration and liquids recovery processes used to process natural gas or refinery gas streams to recover products such as olefins and higher molecular weight hydrocarbons, for example, solid-bed desiccant adsorption followed by refrigerated condensation, cryogenic expansion, or circulating absorption oil or other solvent, as, may be employed in the processes of the present invention. Unreacted alkanes may be recycled to the bromination reactor 60 via line 82, while C₃₊ hydrocarbon products and carbon disulfide are transported via lines 84 and 86, respectively, for further processing, storage or sale.

The effluent wash stream from products separation unit 80 which typically is either hydrobromic acid where water is used to dissolve HBr or an aqueous solution of sodium hydroxide where the gas stream is contacted with a caustic solution is transported via line 88 to bromine recovery unit 90. HBr or NaBr may be removed from the effluent wash stream by air or chemical oxidation or electrolysis in the bromine recovery unit 90 to form elemental bromine which may be recycled via line 58 to bromination reactor 60.

While the processes of the present invention have been described above and illustrated in FIG. 4 as being incorporated into a gas-to-fuels process involving bromination and synthesis steps, it will be apparent to a skilled artisan in possession of this description that the processes of the present invention may be incorporated in other chemical processes in which it may be desirable to convert hydrogen sulfide to carbon disulfide, including, but not limited to, “gas-to-methanol”, “gas-to-ammonia” and “gas-to-liquids” (Fischer-Tropsch) processes.

Certain embodiments of the methods of the invention are described herein. Although major aspects of what is believed to be the primary chemical reactions involved in the methods are discussed in detail as it is believed that they occur, it should be understood that side reactions may take place. One should not assume that the failure to discuss any particular side reaction herein means that that reaction does not occur. Conversely, those that are discussed should not be considered exhaustive or limiting. Additionally, although figures are provided that schematically show certain aspects of the methods of the present invention, these figures should not be viewed as limiting on any particular method of the invention.

The term “high molecular weight hydrocarbons” as used herein refers to hydrocarbons comprising C₃ chains and longer hydrocarbon chains. In some embodiments, the higher molecular weight hydrocarbons may be used directly as a product (e.g., LPG, motor fuel, etc.). In other instances, the higher molecular weight hydrocarbon stream may be used as an intermediate product or as a feedstock for further processing. In other instances, the higher molecular weight hydrocarbons may be further processed, for example, to produce gasoline grade fuels, diesel grade fuels, and fuel additives. In some embodiments, the higher molecular weight hydrocarbons obtained by the processes of the present invention can be used directly as a motor gasoline fuel having a substantial aromatic content, as a fuel blending stock, or as feedstock for further processing such as an aromatic feed to a process producing aromatic polymers such as polystyrene or related polymers or an olefin feed to a process for producing polyolefins. The term “olefins” as used herein refers to hydrocarbons that contain two to six carbon atoms and at least one carbon-carbon double bond. The olefins may be further processed if desired. For instance, in some instances, the olefins produced by the processes of the present invention may be further reacted in a polymerization reaction (for example, a reaction using a metallocene catalyst) to produce poly(olefins), which may be useful in many end products such as plastics or synthetic lubricants.

The end use of the high molecular weight hydrocarbons, the olefins or mixtures thereof may depend on the particular catalyst employed in the oligomerization portion of the methods discussed below, as well as the operating parameters employed in the process. Other uses will be evident to those skilled in the art with the benefit of this disclosure.

In some embodiments, the present invention comprises reacting a feed gas stream with bromine from a suitable bromine source to produce alkyl bromides. As used herein, the term “alkyl bromides” refers to mono, di, and tri-brominated alkanes, and combinations of these. These alkyl bromides may then be reacted over suitable catalysts so as to form olefins, higher molecular weight hydrocarbons or mixtures thereof.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. All numbers and ranges disclosed above may vary by some amount. Whenever a numerical range with a lower limit and an upper limit is disclosed, any number and any included range falling within the range are specifically disclosed.

1. A process comprising:
contacting a gaseous stream comprising lower molecular weight alkanes and hydrogen sulfide with sufficient bromine at a temperature to convert substantially all of said hydrogen sulfide to carbon disulfide.

2. The process of claim 1 wherein the gaseous stream contains from about 0.001 to about 20 mol % hydrogen sulfide.

3. The process of claim 1 wherein said temperature is from about 250° C. to about 530° C.

4. The process of claim 1 wherein the molar ratio of bromine to hydrogen sulfide is about 2:1.

5. The process of claim 1 wherein hydrogen bromide is also formed during conversion of said hydrogen sulfide to carbon disulfide, said process further comprising:
removing at least a portion of said hydrogen bromide from said gas stream.

6. The process of claim 5 wherein said step of removing comprises contacting said gas stream with water so as to selectively dissolve hydrogen bromide and form hydrobromic acid.

7. The process of claim 5 wherein said step of removing comprises contacting said gas stream with an aqueous solution of sodium hydroxide, said hydrogen bromide reacting with said sodium hydroxide to form sodium bromide,

8. The process of claim 1 wherein said step of removing comprises distilling said gas stream.

9. The process of claim 5 further comprising:
converting at least a portion of the hydrogen bromide to bromine.

10. The process of claim 9 wherein said step of converting comprises reacting said at least a portion of the hydrogen bromide with oxygen.

11. The process of claim 9 wherein said step of converting comprises electrolysis.

12. A process comprising:
contacting a gaseous stream comprising lower molecular weight alkanes and hydrogen sulfide with bromine at a temperature so as to form alkyl bromides, carbon disulfide and hydrogen bromide;
reacting at least a portion of said alkyl bromides in the presence of a suitable catalyst, said hydrogen bromide and said carbon disulfide to form higher molecular weight hydrocarbons, olefins or mixtures thereof.

13. The process of claim 12 wherein the gaseous stream contains from about 0.001 to about 20 mol % hydrogen sulfide.

14. The process of claim 12 wherein said temperature is from about 250° C. to about 600° C.

15. The process of claim 12 further comprising:
removing at least a portion of said hydrogen bromide from said higher molecular weight hydrocarbons, olefins or mixtures thereof.

16. The process of claim 15 wherein said step of removing comprises contacting said higher molecular weight hydrocarbons, olefins or mixtures thereof with water so as to selectively dissolve hydrogen bromide and form hydrobromic acid.

17. The process of claim 15 wherein said step of removing comprises contacting said higher molecular weight hydrocarbons, olefins or mixtures thereof with an aqueous solution of sodium hydroxide, said hydrogen bromide reacting with said sodium hydroxide to form sodium bromide.

18. The process of claim 15 further comprising:
converting at least a portion of the hydrogen bromide to bromine.

19. The process of claim 18 wherein said step of converting comprises reacting said at least a portion of the hydrogen bromide with oxygen.

20. The process of claim 18 wherein said step of converting comprises electrolysis.
